(19) United States
(12) Patent Application Publication
(10) Pub. No.: US 2013/0033406 A1
(43) Pub. Date: Feb. 7, 2013

(54) ANTENNA AND METHOD FOR MANUFACTURING SAME

(71) Applicants: JungHoon Chae, Suwon (KR); JungMin Kim, Suwon (KR)

(72) Inventors: JungHoon Chae, Suwon (KR); JungMin Kim, Suwon (KR)

(73) Assignees: AMERICAN AUDIO COMPONENTS INC., La Verne, CA (US); AAC ACOUSTIC TECHNOLOGIES (SHENZHEN) CO., LTD., Shenzhen (CN)

(21) Appl. No.: 13/531,881

(22) Filed: Jun. 25, 2012

(30) Foreign Application Priority Data
Aug. 4, 2011 (CN) 201110222420.0

(51) Int. Cl. H01Q 1/36; H01B 13/00

(52) U.S. Cl. 343/787; 216/20

(57) ABSTRACT

A method for manufacturing an antenna includes the steps of: providing a ceramic substrate and forming an antenna pattern on the ceramic substrate using screen printing with metallic material; firing the ceramic substrate and the antenna pattern by a high temperature; treating the ceramic substrate by chemical wet-etching process; pasting an adhesive tape to the antenna pattern, then detaching the antenna pattern from the ceramic substrate, and the combination of the adhesive tape with the antenna pattern forming a conductor tape; making the conductor tape attached to a first face of a ferrite plate.

### FIELD OF THE INVENTION

The present disclosure relates to radio frequency identification technologies, and more specifically to an antenna and a method for manufacturing the antenna.

### DESCRIPTION OF RELATED ART

With the rapidly development of radio frequency identification technologies, radio frequency identification (RFID) tags are widely used in various fields such as distribution, logistic, material handling industries, and non-contact integrated circuits.

A related radio frequency identification tag includes an antenna and an integrated circuit connected with the antenna for providing object information. And there are various methods provided for manufacturing a radio frequency antenna, such as entwining enameled wires, printing silk screen, and making flexible printed circuit boards (FPCB).

A conventional antenna which is made of FPCB consists of an insulator layer, a conductive layer having an antenna pattern, and adhesive tapes disposed therebetween. However, the cost for manufacturing such an antenna is increased because the cost of the FPCB unit is high and the FPCB is required for at least two adhesive tapes. Further, it's difficult to make a thin antenna by using FPCB because a typical height of FPCB is at least 0.1 mm and the total thickness of the antenna is accordingly increased. Otherwise, the antenna made of FPCB is easy to be broken up because of the poor flexibility of the FPCB.

Therefore, it is desirable to provide a new antenna and a new method which can overcome the above-mentioned problems.

### BRIEF DESCRIPTION OF THE DRAWINGS

Many aspects of the embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric and exploded view of an antenna in accordance with an exemplary embodiment of the present disclosure;

FIG. 2 shows an antenna pattern forming on a ceramic substrate shown in FIG. 1.

FIG. 3 shows an adhesive tape detaching the antenna pattern from the ceramic substrate.

FIG. 4 shows the adhesive tape and the antenna pattern disposed on a ferrite plate.

FIG. 5a, 5b illustrate two optional suggestions to finish the step in FIG. 4.

FIG. 6 shows a plastic film and a double-faced adhesive tape ready to be attached to the adhesive tape and the antenna pattern.

### DETAILED DESCRIPTION OF THE EMBODIMENT

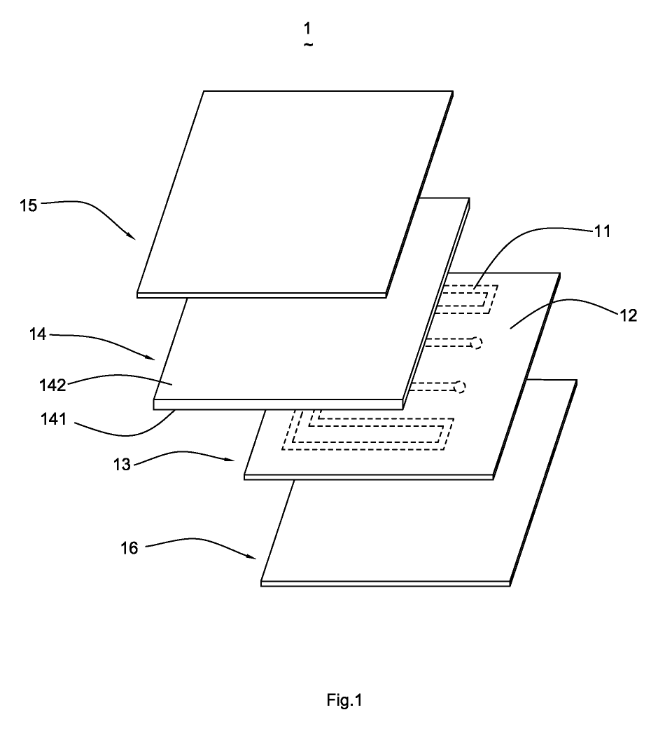

Referring to FIG. 1, an antenna 1 includes a ferrite plate 14, a conductor tape 13 attached to a first face 141 of the ferrite plate 14, a plastic film 15 attached to a second face 142 of the ferrite plate 14 opposite to the first face 141. The conductor tape 13 includes an adhesive tape 12 and an antenna pattern 11 pasted to the adhesive tape 12. A double-faced adhesive tape 16 is attached to the conductor tape 13 so that the antenna 1 could be pasted to a terminal device.

The ferrite plate 14 is made from ferrite material. By virtue of it's high resistivity and magnetic permeability, the ferrite plate 10 is able to lead the magnetic field. The plastic film 15 is made from transparent polyester film.

A method for manufacturing the antenna described above comprises the processes below.

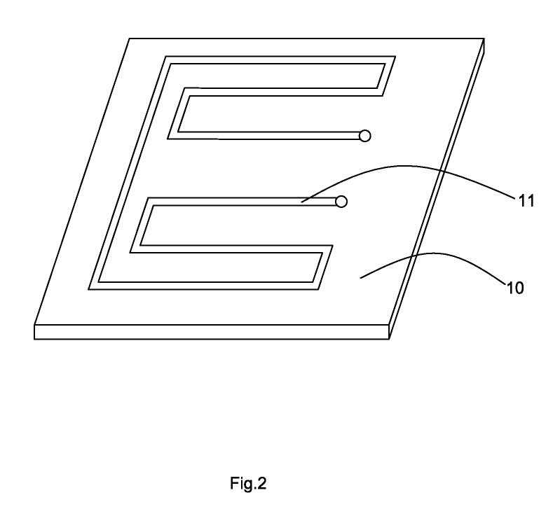

Firstly, referring to FIG. 2, provide a ceramic substrate 10, and forming an antenna pattern 11 on the ceramic substrate 10 using screen printing with metallic material, such as Ag, Ni, Au, Cu, and so on. The ceramic substrate 10 is made from ceramic material, for example aluminium trioxide, silicon-dioxide, zirconium dioxide and so on.

Secondly, co-fire the ceramic substrate 10 and the antenna pattern 11 by high temperature ranged from 600° C. to 1300° C.

Thirdly, treat the ceramic substrate 10 and the antenna pattern 11 by chemical wet-etching process.

Fourthly, plate the antenna pattern 11 with metallic material of Ni, Au, Cu, Ag, and so on. And this process is optional and may be omitted in other embodiment.

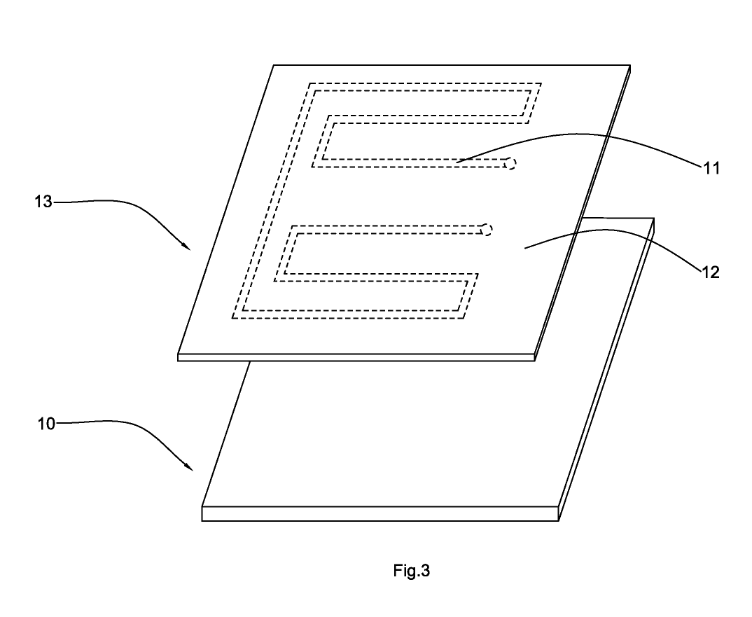

Fifthly, referring to FIG. 3, paste an adhesive tape 12 to the antenna pattern 11 on the ceramic substrate 10, and then detach the antenna pattern 11 from the ceramic substrate 10., The combination of the adhesive tape 12 with the antenna pattern 11 forms the conductor tape 13;

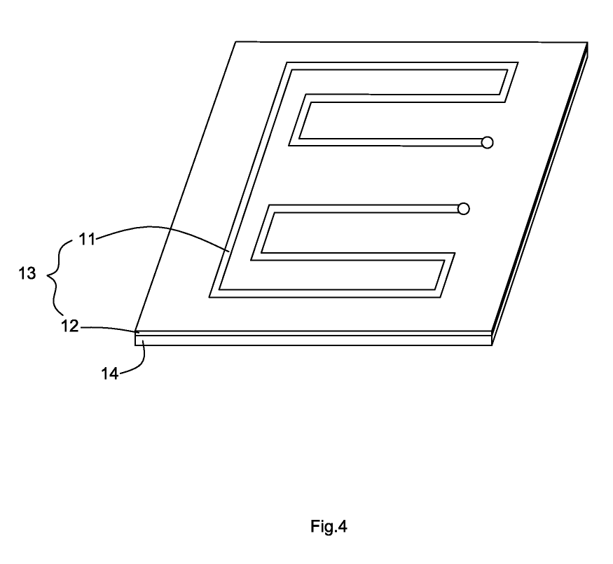

Sixthly, referring to FIG. 4, make the conductor tape 13 attached to the first face 141 of a ferrite plate 14.

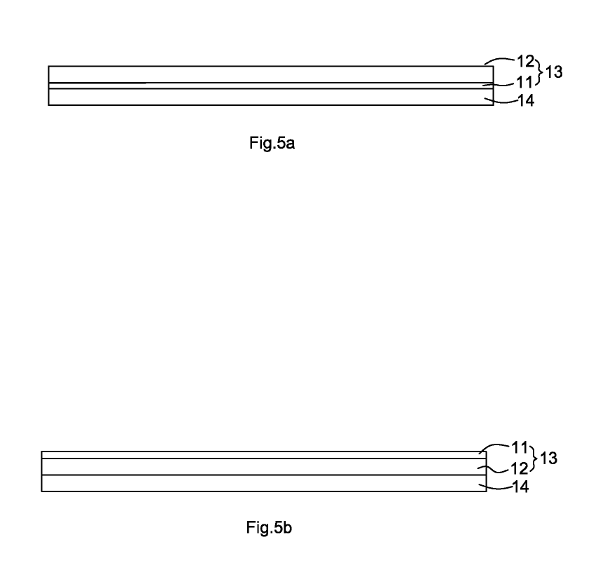

Referring to FIG. 5a, the antenna pattern 11 is disposed between the adhesive tape 12 and the ferrite plate 14.

Referring to FIG. 5b, the adhesive tape 12 could be alternatively disposed between the antenna pattern 11 and the ferrite plate 14.

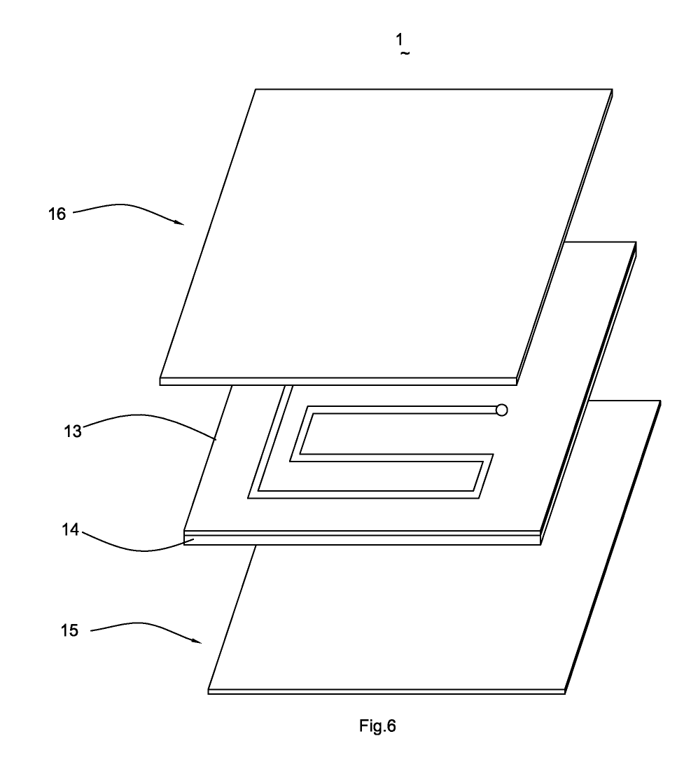

Seventhly, referring to FIG. 6, the plastic film 15 is attached to the second face 142 of the ferrite plate 14, and the double-faced adhesive tape 16 is attached to the conductor tape 13.

The antenna 1 according to the present disclosure has a thickness of only 0.03 millimeters which is much smaller than the one made from FPCB. Otherwise, the method is easy for mass production and make the cost cut down. Further, the antenna 1 made by the above-mentioned processes has a stable structure and good flexility.

It will be understood that the above-mentioned particular embodiment is shown and described by way of illustration only. The principles and the features of the present disclosure may be employed in various and numerous embodiments thereof without departing from the scope of the disclosure as claimed. The above-described embodiment illustrates the scope of the disclosure but do not restrict the scope of the disclosure.

What is claimed is:

1. A method for manufacturing an antenna, the method comprising:
providing a ceramic substrate, and forming an antenna pattern on the ceramic substrate using screen printing with metallic material;
co-firing the ceramic substrate and the antenna pattern by a high temperature;
treating the ceramic substrate by chemical wet-etching process;
pasting an adhesive tape to the antenna pattern, then detaching the antenna pattern from the ceramic substrate, and the combination of the adhesive tape with the antenna pattern forming a conductor tape;
making the conductor tape attached to a first face of a ferrite plate.

2. The method for manufacturing an antenna as claimed in claim 1, wherein the metallic material for forming the antenna pattern is selected from Ni, Au, Cu, Ag.

3. The method for manufacturing an antenna as claimed in claim 1, wherein the high temperature is ranged from 600° C. to 1300° C.

4. The method for manufacturing an antenna as claimed in claim 2, wherein the antenna pattern is plated with metallic material after being co-fired.

5. The method for manufacturing an antenna as claimed in claim 4, wherein the metallic material plated on the antenna pattern is selected from Ni, Au, Cu, Ag.

6. The method for manufacturing an antenna as claimed in claim 1, wherein a double-sided adhesive tape is pasted to the conductor tape.

7. The method for manufacturing an antenna as claimed in claim 6, wherein a plastic film is pasted to a second face of the ferrite plate which is opposite to the first face thereof.

8. An antenna, comprising:
a ferrite plate defining a first face and a second face opposite to the first face;
a conductor tape attached to the first face of the ferrite plate; wherein
the conductor tape includes an adhesive tape and an antenna pattern attached to the adhesive tape.

9. The antenna as claimed in claim 8, wherein the antenna pattern is made of material selected from Ni, Au, Cu, Ag.

10. The antenna as claimed in claim 8, wherein a plastic film is disposed on the second face of the ferrite plate.

11. The antenna as claimed in claim 9, wherein a double-faced adhesive tape is disposed on the conductor tape.

12. The antenna as claimed in claim 8, wherein the plastic film is made from transparent polyester film.

13. The antenna as claimed in claim 8, wherein the antenna pattern is disposed between the adhesive tape and the ferrite plate.

14. The antenna as claimed in claim 8, wherein the adhesive tape is disposed between the antenna pattern and the ferrite plate.
